(19) United States
(12) Patent Application Publication
(10) Pub. No.: US 2004/0198446 A1
(43) Pub. Date: Oct. 7, 2004

(54) Mass storage for wireless communication

(76) Inventors: Wen-Tsung Liu, Shindian City (TW); Hsiang-An Hsieh, Shindian City (TW)

Correspondence Address: Carry Computer Eng. Co., Ltd., P.O. Box No.6-57, Chung-Ho, Taipei, 235, TW

(21) Appl. No.: 10/302,890

(22) Filed: Nov. 25, 2002

(30) Foreign Application Priority Data
Sep. 19, 2002 (TW) 091121409

(51) Int. Cl. H04B 1/38

(52) U.S. Cl. 455/558; 455/550.1; 455/556.1

(57) ABSTRACT

A mass storage for wireless communication uses a simulation memory card inserted in a digital device and a storage capable of receiving wireless communication signals to conduct information transmission; wherein the simulation memory card has a memory card connector, a memory card controller and a wireless communication interface module to receive the digital device for transmitting and storing commands through the wireless communication interface. The memory card controller simulates the standard memory card input and output as well as the communication protocol to receive commands of the digital device and data transmission; it also controls the storage via the wireless communication interface module to access the stored data.

### BACKGROUND OF THE INVENTION

1) Field of the Invention

The present invention relates to a mass storage, more particularly to a mass storage for a wireless communication.

2) Description of the Prior Art

With the miniaturization of the information product, the prices of the small-sized flash memory storage cards (to be referred as mini-memory cards hereon) have been raised high due to the rapidly increasing market demand; among them, the compact flash card (CF), PCMCIA card (PC), memory stick card (MS) and secure digital card (SD)/multimedia card (MMC) have the most potential prospect. All of them use the silicon chip for storage and that has been used in various infor-products or digital electronic device via a specific electric interface. The advantages of the mini-memory card are that it has smaller volume, light weight and large capacity; it is also electricity-saving, vibration resistant and reliable. The mini-memory card has been extensively applied to different kinds of digital information devices, more especially, the portable digital electronic device, such as the digital still camera (DSC), digital music player, digital camcorder and MP3.

However, the application of the mini-memory card is limited by the silicon chip manufacture, its volume and electricity consumption. The highest capacity thereof still fails to surpass that of some of the high-capacity conventional storage media, such as the hard disc drive and compact disc drive. For example, the highest capacity of SD is about 256 MB and that of MS only reaches 128 MB. For a digital camera with 6 megapixels, each of the photo occupied at least about 3 MB. In other words, each SD only store about 40 to 70 photos and that fails to meet the user's need.

In order to solve the abovementioned problem of not having enough capacity, the user might purchase more mini-memory cards for alternatively conducting the storage operation. However, the average capacity cost of the mini-memory card is far higher than that of a traditional storage media. Purchasing more cards definitely burdens the user. Therefore, some of the industrials use the hard disc drive to combine a control circuit board disposed with a slot as the storage copy device for the mini-memory card. That means, when the mini-storage card almost runs out, it is taken out from the digital electronic device and the mini storage copy device (or hard disc drive) is used for conducting simple information transmission, storage or copy. Then the mini-storage card is reformatted or the original information is deleted for repetitive usage.

The conventional mini-memory card copy device solves the problems of not having enough capacity, purchasing more storage cards and increasing the user's cost. However, the constant extracting and inserting the mini-memory card into the copy device complicates the operation or confuses the user by recognizing the result of transmission or copy. Once any mal-function occurs, the information originally stored on the mini-memory card disappears right away and that might trouble the user.

### SUMMARY OF THE INVENTION

In viewing the abovementioned shortcomings of the mini-memory card and in order to achieve the other effects and objectives, the inventor of the present invention researched, tested and finally developed a mass storage for wireless communication. The concept of the main design is to provide a simulation memory card to be inserted into a memory inserting slot of a digital device; the function of its operation interface directly stores, browses or deletes the digital data captured by the device to the present invention of the mass storage via the method of wireless communication; or it directly and wirelessly provides and transmits the data stored on the mass storage to the bilateral transmission function used by the digital device via the simulation memory card.

The present invention requires no additional and independent operation interface for achieving the objectives of expanding the storage capacity and tremendous lowering the cost; no purchasing of additional mini-memory card is required. In addition, the present invention is convenient to operate. More especially, the simulation memory card includes compact flash card type I/II, PCMCIA card type I/II/III, memory stick card, smart media/XD card and secure digital card/multimedia card.

Wherein the memory card connector simulates the electric interface and mechanical dimension of the available and standardized mini-memory card; it also combines with a wireless communication interface module to conduct wireless information communication and transmission with the mass storage device. Therefore, the user directly inserts the present invention into the inserting slot for the mini-memory card of the digital device for expanding the storage capacity of the digital device. Furthermore, the operation is the most convenient one and capable of solving the problems of constantly extracting and inserting the memory card as well as being unable to know the copy result of the mini-memory copy device.

Another objective of the present invention is to dispose a wireless communication interface module in the storage for receiving the communication commands transmitted by the simulation memory card and converting them into the interface suitable for the mass storage device. Wherein, the mass storage is either built-in or connected externally to engage with the storage.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is a diagram of the preferred exemplary embodiment of the present invention.

FIG. 2 is a diagram of a hardware function of a storage of the present invention.

FIG. 3 is a drawing of a hardware circuit of a simulation compact flash card of the present invention.

FIG. 4 is a drawing of a hardware circuit of FIG. 3 and a storage wireless communication.

FIG. 5 is a circuit drawing of the present invention simulating a secure digital card.

FIG. 6 is a circuit drawing of the present invention simulating a memory stick card.

FIG. 7 is a circuit drawing of the present invention simulating a PCMCIA card.

### DETAILED DESCRIPTION OF THE PREFERRED EMBODIMENTS

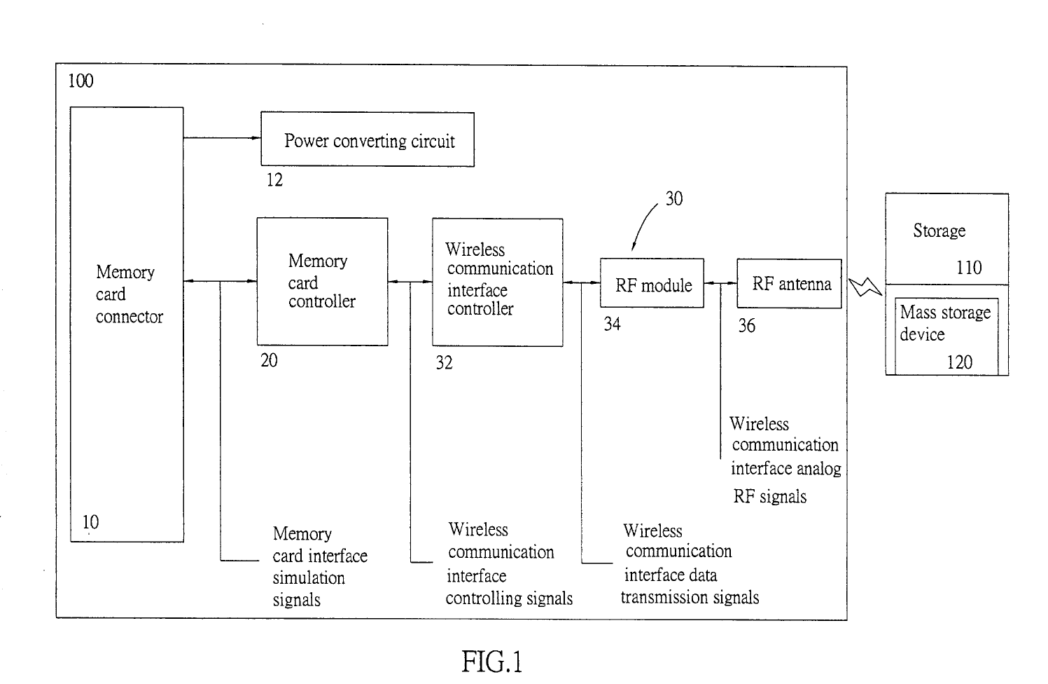

FIG. 1 is a diagram of a preferred exemplary embodiment of the present invention. The present invention of a mass storage for wireless communication uses a simulation memory card (100) inserted in a digital device, such as a notebook computer, a personal digital assistant, a digital camera, a digital camcorder, MP3 or other digital communication device, to conduct information transmission with a storage (110) capable of receiving wireless communication signals. The simulation memory card (100) has a memory card connector (10), a memory card controller (20) and a wireless communication interface module (30). The memory card controller (20) simulates an input/output interface and communication protocol of a standard memory card and receives the commands of the digital device via the wireless communication interface module (30) to convert said commands into wireless communication and commands for transmitting gathered data to the storage (110); the storage (110) receives the commands and data transmitted by the memory card controller (20) via the wireless communication interface and store them to a mass storage device (120); furthermore, it transmits the storage result back to the memory card controller (20) via the wireless communication interface.

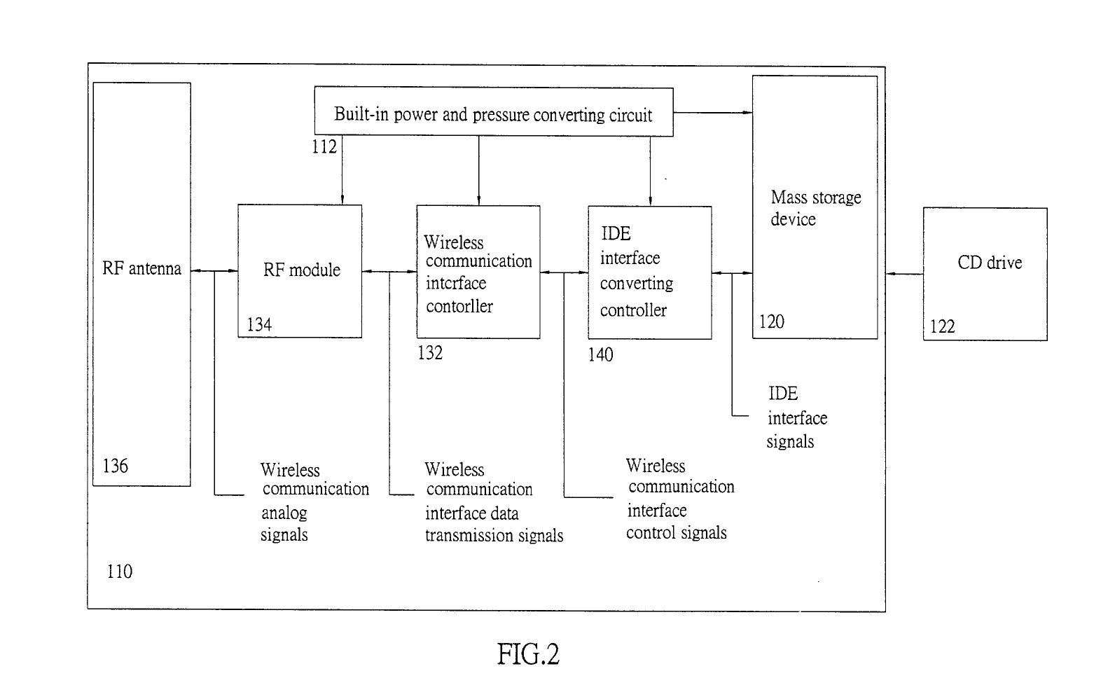

Said wireless communication interface module (30) has a wireless communication interface controller (32), a radio frequency (RF) module (34) and a RF antenna (36). In other words, after converting the commands into a communication protocol and commands suitable for the wireless communication interface module (30), the memory card controller (20) transmits them to the RF antenna (36) via the wireless communication controller (32) and the RF module (34). FIG. 2 shows the diagram of the hardware function of the storage (110) of the present invention. The storage (110) further has a corresponding wireless communication module including also a wireless communication controller (132), a RF module (134), a RF antenna (136), an IDE interface converting controller (140) and a mass storage device (120). In addition, the storage (110) also has a built-in power and pressure converting circuit (112) for providing suitable power and pressure required by the corresponding wireless communication interface module (30), the IDE interface converting controller (140) and the mass storage device (120).

What needs to be emphasized is that the present invention only adapts the regular and popular IDE interface as the transmission interface for connecting the mass storage device (120). Therefore, the present invention needs to have the controller (140) for converting the wireless communication to IDE interface storage device. However, the other interface controllers, such as IDE/ATA, IDE/ATAPI, USB or IEEEE1394 are adaptable also.

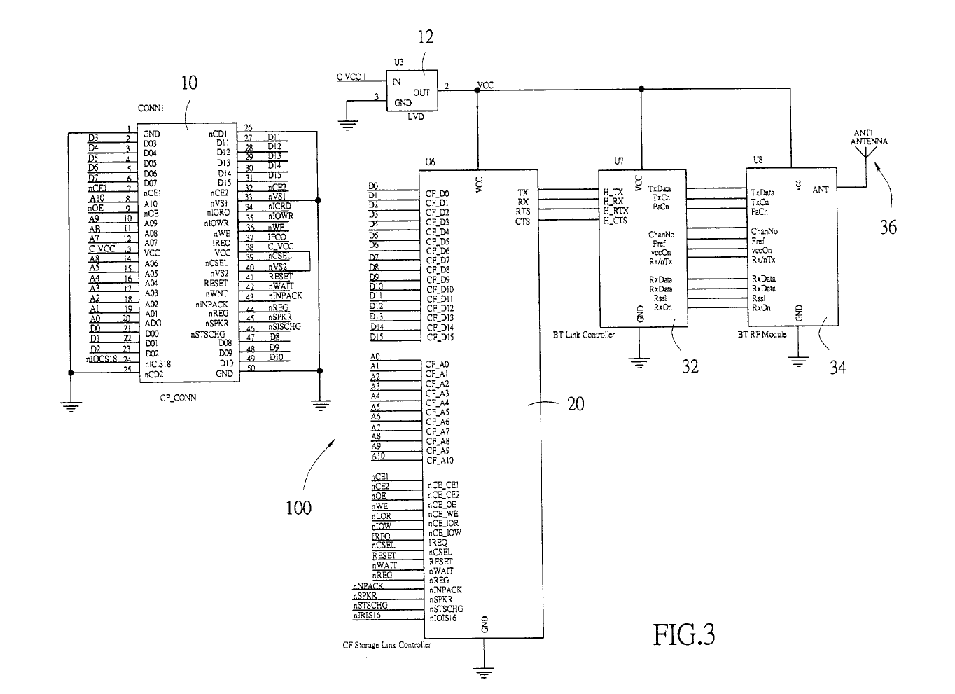

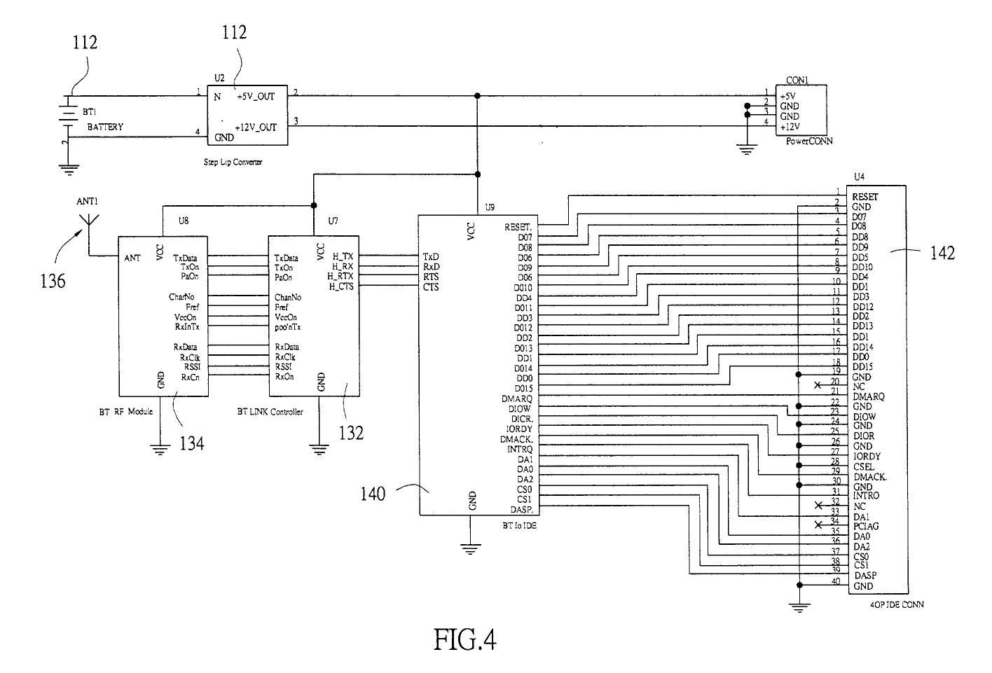

FIGS. 3 and 4 show hardware circuits of a simulation compact flash (CF) card and its storage wireless communication of the present invention. The simulation memory card (100) includes a built-in power converting circuit (12), the memory card connector (10), the memory card controller (20), the wireless communication interface controller (32), the RF module (34) and the RF antenna (36). Wherein the power converting circuit (12) converts the provided power to a power or pressure suitable for the internal parts to used; it also has the function of protecting the power and stabilizing the pressure. When the simulation CF memory card connector (10) inserts into the digital device, the interface of the digital device transmits information to the storage (110) through the wireless communication interface controller (32), the RF module (34) and the RF antenna (36) of the simulation CF memory card (10).

As indicated in FIG. 4, first, the built-in power and pressure converting circuit (112) provides the power needed for the controller (140) to convert the wireless communication interface to the IDE interface storage device and the mass storage device (120) of the IDE interface. In addition to a regular IED interface hard disc drive (HDD), the mass storage device (120) includes burnable compact disc drive (CD-RW), burnable high capacity compact disc drive (DVD-RW, DVD-RAM), magnetic compact disc drive (MO), Zip magnetic disc drive or built-in, and rewritable memory (Flash Memory). When the wireless communication interface controller (132) and the RF module (134) connect with the signals of the wireless communication interface, that means, the corresponding RF antenna (136) receives the wireless communication commands transmitted by the simulation memory card (100), the controller (140) converting the wireless communication to IDE interface storage device converts the commands of the wireless communication interface connecting the mass storage device (120) and the communication protocol to the standard supported by the storage device of the IDE interface for conducting storing operation. Only an IDE interface connector (142) is displayed in FIG. 4. in addition, via the wireless communication interface including the wireless communication interface controller (132), the RF module (134) and the RF antenna (136), information of the storage result exchanges with the simulation memory card (100) to achieve the objective of simulating the standard CF memory card on the digital device.

The built-in power and pressure converting circuit (112) converts the power from a battery or an internal connection to a +5V and +12V power suitable for the wireless communication interface module (30), the controller (140) converting the wireless communication interface to IDE interface and the inner portion of the mass storage device (120) to use. If the battery power is not enough, a user either replaces the battery or directly connects it with an external and regular direct current power. Furthermore, the power and pressure converting circuit (112) has the function of protecting the power and stabilizing the pressure so as to prevent the mass storage device (120) of the present invention from the damage caused by unsteady or not enough power and pressure.

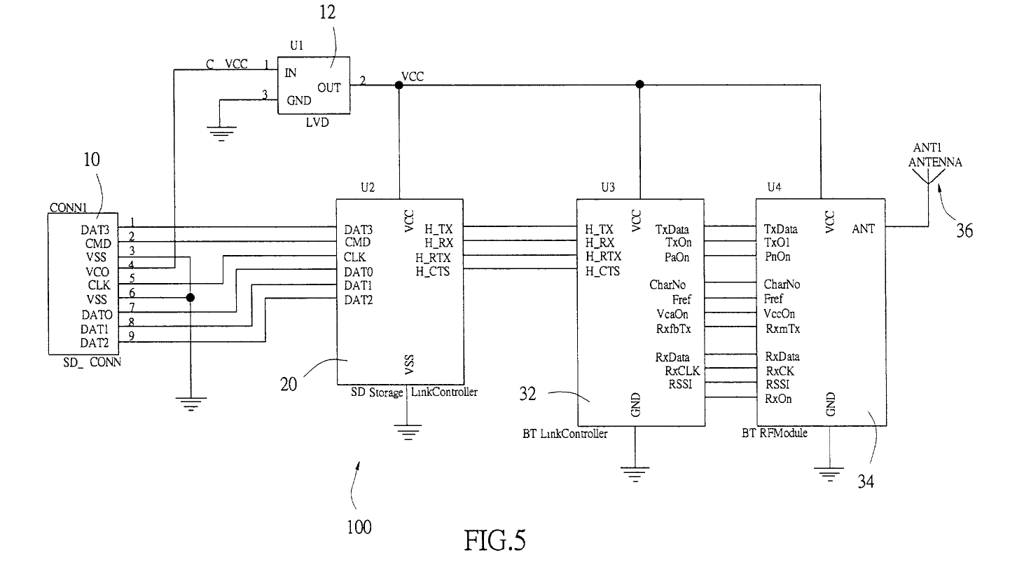

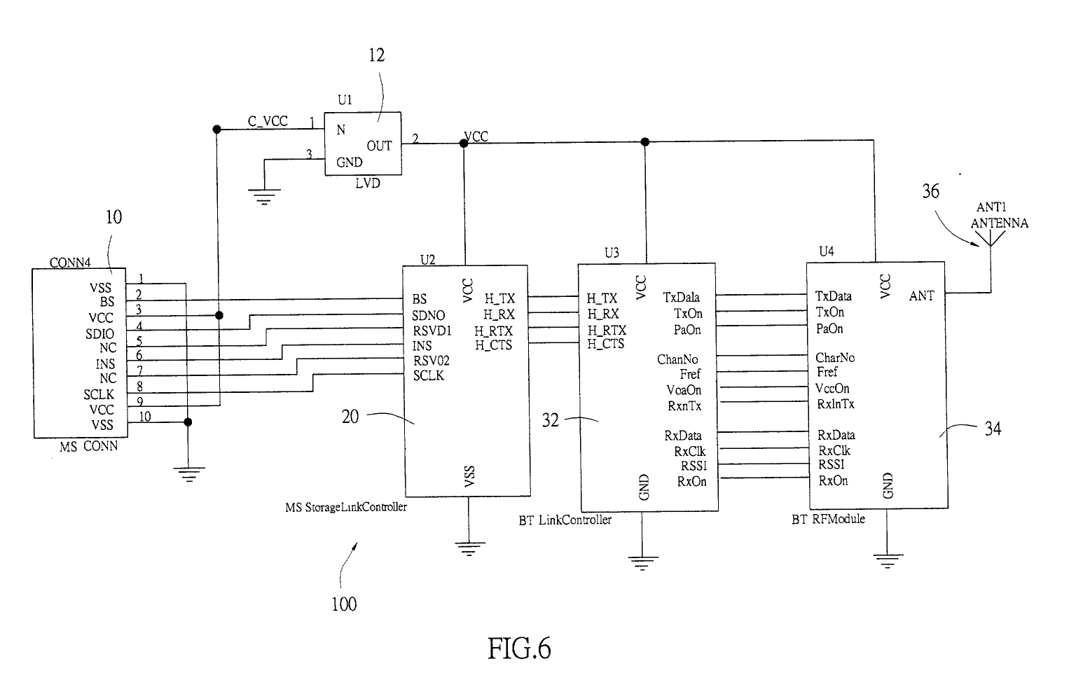

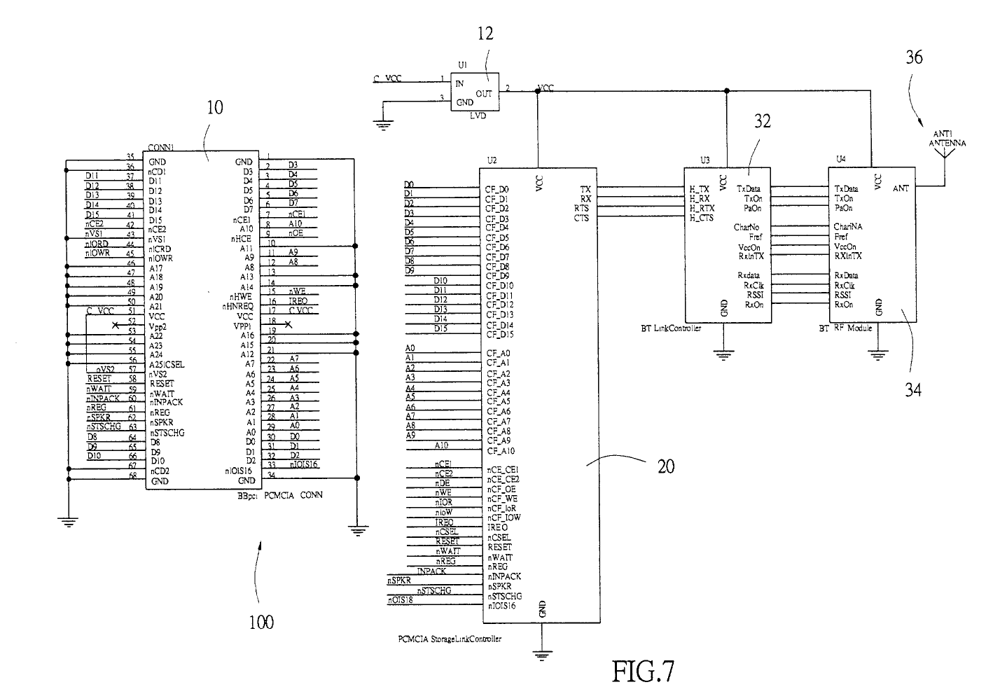

FIGS. 5 to 7 shows the present invention simulating the circuits of a secure digital (SD) card, a memory stick (MS) and a PCMCIA card (PC). However, the principles and applications of the simulation cards of SD/MMC (Multimedia Card), MS and PC are the same as the abovementioned. They will not be described again.

More especially, in addition to the abovementioned IDE interface hard disc drives, the mass storage device (120) of the present invention can also be a movable compact disc drive (122) or other movable storage device.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A mass storage for wireless communication uses a simulation memory card inserted in a digital device and a storage capable of receiving wireless communication signals to conduct information transmission; wherein the simulation memory card comprises a memory card connector, a memory card controller and a wireless communication interface module; the memory card controller simulates the standard memory card input and output as well as the communication protocol to receive commands of the digital device for transmission and storage.

2. The mass storage for wireless communication according to claim 1, wherein the wireless communication interface module comprises a wireless communication interface controller, a radio frequency (RF) module and a RF antenna; in other words, the memory card controller converts the commands into a communication protocol and commands suitable for the wireless communication interface module to use and transmits them to the RF antenna via the wireless communication controller and the RF module.

3. The mass storage for wireless communication according to claim 1, wherein the storage further comprises a corresponding wireless communication interface module, an IDE interface converting controller and a mass storage device.

4. The mass storage for wireless communication according to claim 3, wherein the corresponding wireless communication interface module also comprises a wireless communication interface controller, a RF module and a RF antenna.

5. The mass storage for wireless communication according to claim 3, wherein the IDE interface converting controller comprises IDE/ATA, IDE/ATAPI, USB or IEEEE1394 interface controllers.

6. The mass storage for wireless communication according to claim 3, wherein the storage further comprises a built-in power and pressure converting circuit for providing the suitable power for the corresponding wireless communication interface module, the IDE interface converting controller and the mass storage device to use.

7. The mass storage for wireless communication according to claim 3, wherein the mass storage device comprises a hard disc drive (HDD), a compact disk drive (CD, DVD, MO), a magnetic disc drive (Zip) or a built-in, and rewriteable memory (Flash Memory).

8. The mass storage for wireless communication according to claim 1, wherein the memory card connector comprises a power converting circuit for converting the power and pressure to be suitable for the internal members inside the memory card connector.

9. The mass storage for wireless communication according to claim 1, wherein the memory card connector comprises a compact flash (CF) card.

10. The mass storage for wireless communication according to claim 1, wherein the memory card connector comprises a memory stick (MS) card.

11. The mass storage for wireless communication according to claim 1, wherein the memory card connector comprises a secure digital (SD) card/multimedia card (MMC).

12. The mass storage for wireless communication according to claim 1, wherein the memory card connector comprises a PCMCIA card (PC).
